(19) United States
(12) Patent Application Publication
(10) Pub. No.: US 2011/0010239 A1
(43) Pub. Date: Jan. 13, 2011

(54) MODEL-BASED ADVERTISEMENT OPTIMIZATION

(75) Inventors: Bharat Vijay, Bangalore (IN); Rushi P. Bhatt, Surat (IN); Sanjiv Ghate, Santa Clara, CA (US)

Correspondence Address: Mauriel Kapouytian & Treffert LLP, 151 1st Avenue, #23, New York, NY, 10003, US

(73) Assignee: Yahoo! Inc., Sunnyvale, CA (US)

(21) Appl. No.: 12/501,980

(22) Filed: Jul. 13, 2009

(51) Int. Cl. G06Q 30/00

(52) U.S. Cl. 705/14.42; 705/14.41; 705/14.43

(57) ABSTRACT

Methods and systems are provided for constructing and using an advertisement performance model to predict performances of variations of an advertisement, and to recommend a variation with a better predicted performance than other variations. The advertisement model is constructed utilizing historical advertisement performance information, and is based at least in part on specified model parameters and advertisement parameters. Each variation of the advertisement includes a unique set of advertisement parameter values.

### BACKGROUND

Online advertising has continued to grow in scale and importance. The quality and content of advertisements, which can include textual and other content, format, and other parameters, play an important role in the performance of the advertisement and an advertising or marketing campaign. Advertisement performance is essential in optimizing return return-on-investment and revenue for the advertiser and other parties that may be involved.

Creating advertisements that will perform well under a particular set of circumstances or parameters is challenging, however. Advertising campaign managers (which may broadly include advertisers, agents or associates of advertisers, or other parties) may find the task critical, yet daunting. They may be in possession of important information, including advertising campaign parameters, advertising goals and pertinent performance measures or metrics, content or format parameters relating to advertisements, information relating to advertised goods or services, and other information. However, they may nonetheless lack the time, skills, information, resources, speed or efficiency to effectively design well-performing advertisements, including advertisement creatives. Furthermore, they may lack sufficient information pertaining to the market which may affect advertising performance, or information pertaining to historical performance of advertisements. This is true of both non-keyword-based and keyword-based advertising.

For example, smaller advertising campaign managers who are involved or may wish to become involved in non-keyword-based advertising may have difficulty in efficiently generating well-performing advertisements. Yet maximizing the practicality and inclusivity of advertisers in the advertisement marketplace, and of well-performing advertisements generally, stands to provide many benefits. These may include, for example, an increase revenue for many parties involved, a better experience for users, an increase in the health, competitiveness, scale, efficiency and revenue of the marketplace overall, and more efficient use and monetization of online publisher sites or Web real estate.

There is a need for methods and systems for generating, providing or recommending advertisements or changes, alterations, or improvements to advertisements.

### SUMMARY

In some embodiments, the invention provides methods and systems for constructing and using an advertisement performance model to predict performances of variations of an advertisement, and to recommend a variation with a better predicted performance than other variations. The advertisement model may be constructed utilizing historical advertisement performance information, and is based at least in part on specified model parameters and advertisement parameters. Each variation of the advertisement includes a unique set of advertisement parameter values.

In one embodiment, the invention provides a method including, using one or more computers, obtaining a set of values for each of a set of model parameters associated with an advertisement performance model. The method further includes, using one or more computers, obtaining a set of advertisement parameters associated with variations of an advertisement. The method further includes, using one or more computers, obtaining, from one or more databases, a set of historical advertisement performance information. The method further includes, using one or more computers, constructing and storing the advertisement performance model for use in predicting performances of variations of an advertisement. The advertisement performance model is constructed based at least in part on the set of values for each of the set of model parameters, the set of advertisement parameters, and the set of historical advertisement performance information. The advertisement performance model is used to predict performances of each of a set of variations of the advertisement, each of the set of variations of the advertisement including a unique set of values for the set of advertisement parameters. The method further includes, using one or more computers, using the advertisement performance model to determine predicted performances of each of the set of variations of the advertisement. The method further includes, using one or more computers, providing and storing a recommendation relating to the advertisement. The recommendation is based at least in part on the predicted performances. The recommendation implicitly or explicitly specifies values for each of the set of advertisement parameters. Further, the recommendation specifies a variation, of the set of variations of the advertisement, that is determined to have a predicted performance that is better than a determined predicted performance or performances of one or more other variations of the set of variations of the advertisement.

In another embodiment, the invention provides a system including one or more server computers connected to the Internet and one or more databases connected to the one or more servers. The one or more databases are for storing historical advertisement performance information. The one or more server computers are for obtaining a set of values for each of a set of model parameters associated with an advertisement performance model. The one or more server computers are further for obtaining a set of advertisement parameters associated with variations of an advertisement. The one or more server computers are further for obtaining, from at least one of the one or more databases, a set of historical advertisement performance information. The one or more server computers are further for constructing and storing the advertisement performance model for use in predicting performances of variations of an advertisement. The advertisement performance model is constructed based at least in part on the set of values for each of the set of model parameters, the set of advertisement parameters, and the set of historical advertisement performance information. The advertisement performance model is used to predict performances of each of a set of variations of the advertisement, each of the set of variations of the advertisement including a unique set of values for the set of advertisement parameters. The one or more server computers are further for using the advertisement performance model to determine predicted performances of each of the set of variations of the advertisement. The one or more server computers are further for providing and storing a recommendation relating to the advertisement. The recommendation is based at least in part on the predicted performances. The recommendation implicitly or explicitly specifies values for each of the set of advertisement parameters. Further, the recommendation specifies a variation, of the set of variations of the advertisement, that is determined to have a predicted performance that is better than a determined predicted performance or performances of one or more other variations of the set of variations of the advertisement.

In another embodiment, the invention provides a computer readable medium or media containing instructions for executing a method. The method includes, using one or more computers, obtaining a set of values for each of a set of model parameters associated with an advertisement performance model. The method further includes, using one or more computers, obtaining a set of advertisement parameters associated with variations of an advertisement. The method further includes, using one or more computers, obtaining, from one or more databases, a set of historical advertisement performance information. The method further includes, using one or more computers, constructing and storing the advertisement performance model for use in predicting performance of variations of an advertisement. The advertisement performance model is constructed based at least in part on the set of values for each of the set of model parameters, the set of advertisement parameters, and the set of historical advertisement performance information. The advertisement performance model is used to predict performances of each of a set of variations of the advertisement, each of the set of variations of the advertisement including a unique set of values for the set of advertisement parameters. The method further includes, using one or more computers, using the advertisement performance model to determine predicted performances of each of the set of variations of the advertisement. The method further includes, using one or more computers, providing a recommendation relating to the advertisement. The recommendation is based at least in part on the predicted performances. The recommendation implicitly or explicitly specifies values for each of the set of advertisement parameters. The recommendation further specifies a variation, of the set of variations of the advertisement, determined to have a predicted performance that is better than a determined predicted performance or performances of one or more other variations of the set of variations of the advertisement.

### BRIEF DESCRIPTION OF THE DRAWINGS

FIG. 1 is a distributed computer system according to one embodiment of the invention.

FIG. 2 is a flow diagram of a method according to one embodiment of the invention;

FIG. 3 is a flow diagram according to one embodiment of the invention; and

FIG. 4 is a simplified conceptual block diagram of an advertisement performance model according to one embodiment of the invention.

### DETAILED DESCRIPTION

Methods and systems are provided for constructing and using an advertisement performance model to predict performances of variations of an advertisement, and to recommend a variation with a better predicted performance than other variations. The advertisement model is constructed utilizing historical advertisement performance information, and is based at least in part on specified model parameters and advertisement parameters. Each variation of the advertisement includes a unique set of advertisement parameter values.

In some embodiments, the invention provides methods to optimize advertisements. In various embodiments, the invention can be used to optimize different types of advertisements. This includes, for example, banner or graphical advertisements, whether or not such advertisements are associated with or targeted to Web page content or other information. It further includes content-matched or other matched or targeted advertisements, and can further include keyword-matched or associated advertisements, such as sponsored search advertisements, etc.

As used herein, the term “optimize” broadly includes, among other things, with or without a given set of parameters or limitations, any improvement or suggested improvement, or recommendation or change that may leads to improvement or is predicted to lead to improvement, as well as any determination, selection or recommendation of one or more better or best, or predicted better or best, members of a group.

As used herein, the term “performance” can broadly include and be expressed by any or a combination of various types of information, measures, goals, priorities, or metrics, whether supplied by an advertiser, automatically obtained or determined, or a combination of both, or otherwise. For example, in some embodiments, performance or performance measures can include, or can be specified or determined to include, alone or in combination, among other things, click-through-rate (CTR), cost-per click (CPC), cost-per-action (CPA), cost-per-impression (CPM) performance-based billing, unique or specific user-defined advertisement performance or advertisement campaign performance measures, among other things.

Furthermore, in some embodiments, the term “performance” can include or incorporate a variety of factors or considerations, such as goals of, preferences of, or suitability to an advertiser, publisher or publisher site, advertisement or creative size, campaign goals, or other factors or combinations thereof, whether automatically determined, supplied by one or more parties, a combination of both, or otherwise.

As used herein, the term “model” can broadly include, among other things, any type of algorithm-based construct or conceptual construct, framework, organization, such as a decision tree model, a regression tree algorithm or linear regression model, a model utilizing weighted parameter values, or other types of models or combinations of types.

The invention contemplates embodiments that include building a model using techniques or algorithms such as any type machine learning or artificial intelligence or rule based technique, any Boolean or algebraic technique, etc. In some embodiments, manual hand-coding may be utilized instead of, or in addition to, machine learning. The invention further contemplated embodiments in which an advertiser or other user may influence or take part in defining or specifying aspects of the model.

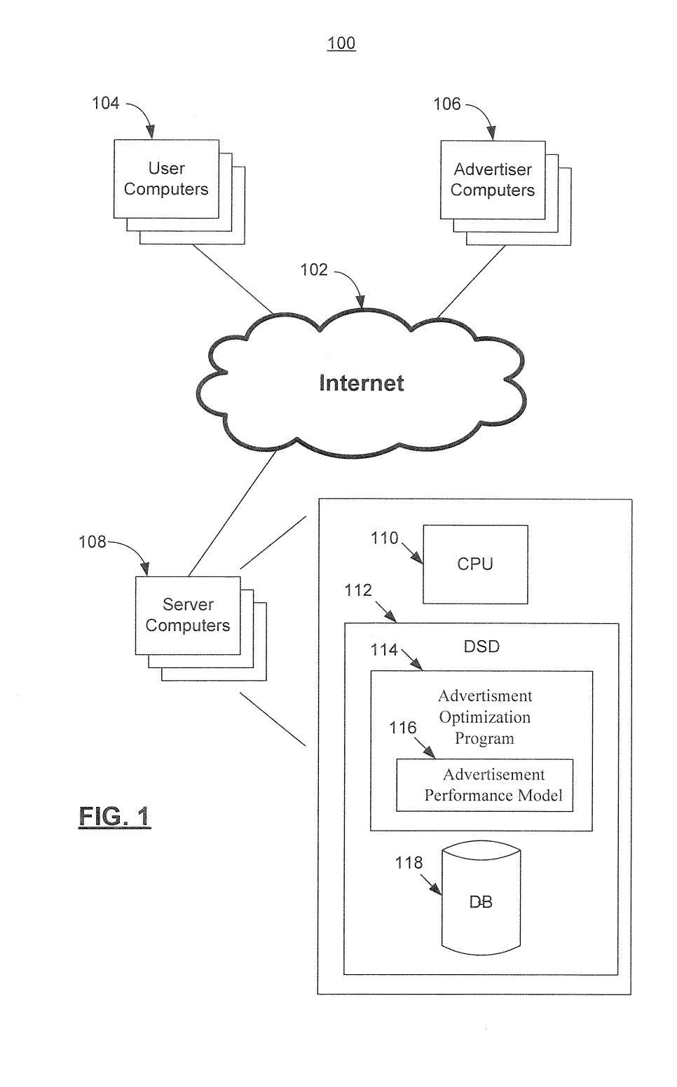

FIG. 1 is a distributed computer system 100 according to one embodiment of the invention. The system 100 includes user computers 104, advertiser computers 106 and server computers 108 connected or connectable to the Internet 102. Although the Internet 102 is depicted, the invention contemplates other embodiments in which the Internet is not includes, as well as embodiments in which other networks are included in addition to the Internet, including one more wireless networks, WANs, LANs, telephone, cell phone, or other data networks, etc. The invention further contemplates embodiments in which user computers or other computers may be or include a wireless, portable, or handheld devices such as cell phones, PDAs, etc.

Each of the one or more computers 104, 106, 108 may be distributed, and can include various hardware, software, applications, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, and software to enable searching, search results, and advertising, such as keyword searching and advertising in a sponsored search context. As depicted, each of the server computers 108 includes one or more CPUs 110 and a data storage device 112.

The data storage device 112 includes one or more databases 118, as well an advertisement optimization program 114 that includes an advertisement performance model 116.

The advertisement optimization program 114 is intended to broadly include all programming, algorithms, applications, software, graphical user interfaces, models, and other and tools necessary to implement or facilitate methods and systems according to embodiments of the invention, whether on one computer or distributed among multiple computers or devices.

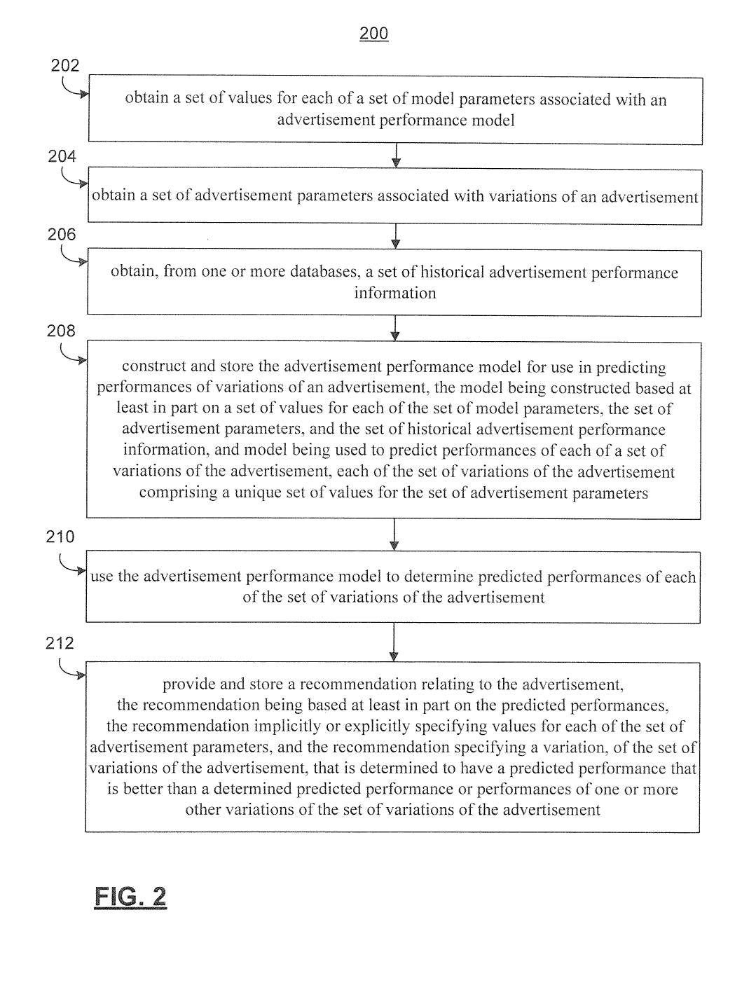

FIG. 2 is a flow diagram of a method 200 according to one embodiment of the invention. The method 200 may be implemented or facilitated using the advertisement optimization program 114, as depicted in FIG. 1, which may include constructing, storing, and using the advertisement performance model 116. Information of various types may be obtained from, as well as stored in, the database 118, or other databases.

At step 202, a set of values are obtained for each of a set of model parameters associated with an advertisement performance model. The model parameters may be used in constructing the model.

At step 204, a set of advertisement parameters associated with variations of an advertisement is obtained. The advertisement may include any of various types of characteristics, content, or format parameters, among other things.

At step 206, a set of historical advertisement performance information is obtained from one or more databases. The set of historical advertisement performance information may include, for example, advertisement and campaign performance information collected and stored from previous or ongoing advertisement campaigns.

At step 208, the advertisement performance model is constructed and stored for use in predicting performances of variations of an advertisement. The model is constructed based at least in part on a set of values for each of the set of model parameters, the set of advertisement parameters, and the set of historical advertisement performance information. The model is used to predict performances of each of a set of variations of the advertisement. Each of the set of variations of the advertisement comprising a unique set of values for the set of advertisement parameters. The model may be, in whole or in part, learned based on machine learning techniques.

At step 210, the advertisement performance model is used to determine predicted performances of each of the set of variations of the advertisement. The variations may each include a unique set of values for the advertisement parameters. The model may be used to determine predicted performances of each variation, and to determine the optimal, better or best variations, based on obtained or supplied parameters, ranges or limitations.

Finally, at step 212, a recommendation is provided relating to the advertisement is provided and stored. The recommendation is based at least in part on the predicted performances. The recommendation implicitly or explicitly specifies values for each of the set of advertisement parameters. For example, the recommendation may suggest that one or more advertisement values be changed, and others left unchanged. Alternatively, the recommendation may provide new advertisements including suggested values for many or all of the advertisement parameters, in some cases in accordance with advertiser supplied information or limitations.

The recommendation specifies a variation, of the set of variations of the advertisement, that is determined to have a predicted performance that is better than a determined predicted performance or performances of one or more other variations of the set of variations of the advertisement.

In some embodiments, recommending an advertisement or variation of an advertisement can include implementing a suggested variation in an advertising campaign, or presenting the suggested variation to the advertisement campaign manager who may choose to have the variation implemented.

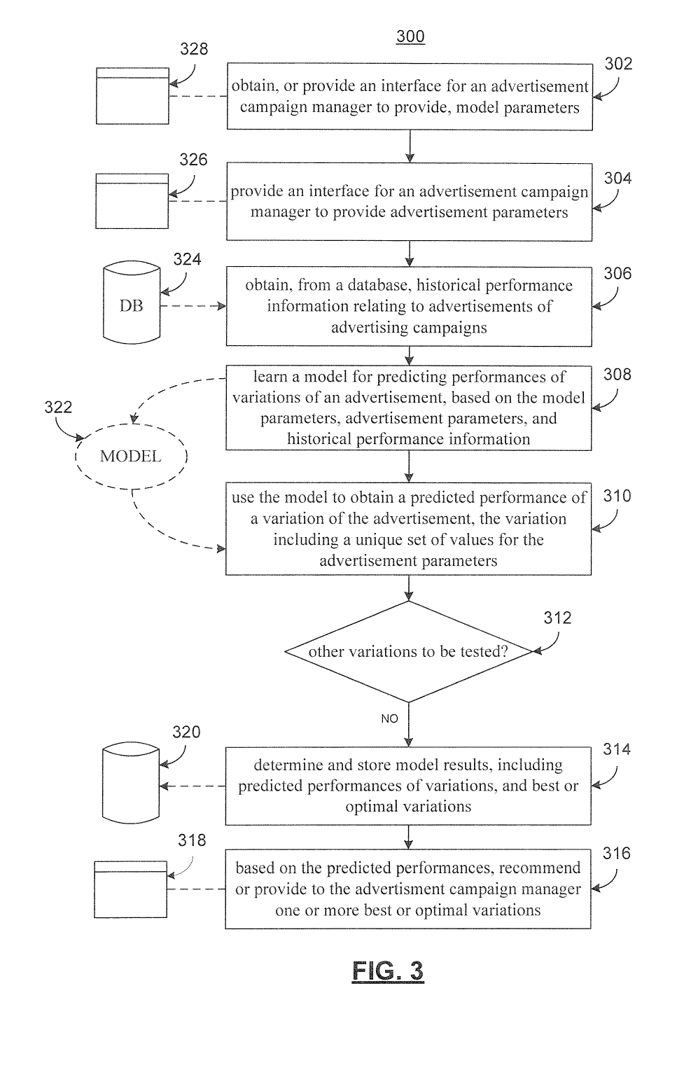

FIG. 3 is a flow diagram 300 according to one embodiment of the invention. At step 302, model parameters are obtained, or an interface 328, such as a Web page-based graphical user interface, is provided for an advertisement campaign manager to provide model parameters, or both.

The method 300 may be implemented or facilitated using the advertisement optimization program 114, as depicted in FIG. 1, which may include constructing, storing, and using the advertisement performance model 116. Information of various types may be obtained from, as well as stored in, the database 118, or other data storage devices or databases.

At step 304, an interface 326 is provided for an advertisement campaign manager to provide advertisement parameters. The advertisement manager may also provide other information, including an advertisement or aspects or portions of an advertisement, a number or maximum number of parameters to be varied, or other information.

At step 306, historical performance information relating to advertisements of advertising campaigns is obtained from a database 324.

At step 308, an advertisement performance model 322 for predicting performances of variations of an advertisement, based on the model parameters, advertisement parameters, and historical performance information.

At step 310, the model 322 is used to obtain a predicted performance of a variation of the advertisement, the variation including a unique set of values for the advertisement parameters relative to the set of values of each of the other variations.

At step 312, the method 300 queries whether other variations remain to be tested, or have their performances predicted using the model 322. If yes, then the method 300 returns to step 310 to test one or more other variations. If no, then the method 300 proceeds to step 314.

At step 314, model results are determined and stored in a database 320, including predicted performances of advertisement variations, and best or optimal variations.

Finally, at step 316, based on the predicted performances, one or more best or optimal advertisement variations are recommended or provide to the advertisement campaign manager. This may include automatically implementing an indicated or optimal variation, or presenting such a variation for the advertisement campaign manager to approve for implementation and, upon such approval, implementing the recommendation.

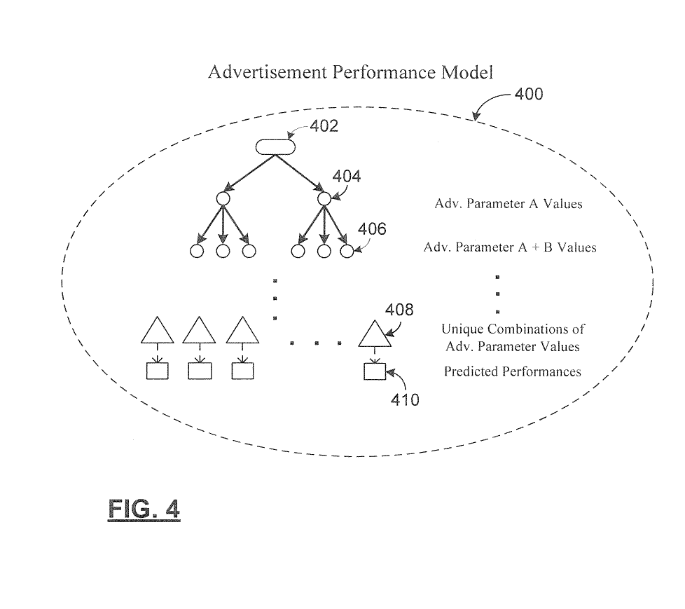

FIG. 4 is a simplified conceptual block diagram of an advertisement performance model 400 according to one embodiment of the invention. FIG. 4 is intended only to give a general understanding of some basic aspects of some embodiments of an advertisement performance model. It is intended to illustrative and partial, and not complete or comprehensive. In various embodiments, the model 400 may part of an advertisement optimization program, may be constructed by an advertisement optimization program, or both, or may be separate from and utilized by an advertisement optimization program.

Although any number of types of models are contemplated by the invention, in some embodiments, a decision tree-type model, as depicted in a simplified way in FIG. 4, may be used.

Box 402 represents the start of a method implemented using the model 400.

Boxes 404 represent variations of an advertisements or partial variations, each variation having a different value for a particular advertisement parameter, specifically, advertisement parameter A. There can be many and varied examples of such an advertisement parameter, such as whether or not the advertisement includes or makes reference to a celebrity, whether the advertisement is considered flashy or not flashy, or a non-binary set of possibilities, contains video or audio, etc.

Boxes 406 represent variations of an advertisement, or partial variations, including specific values for two advertisement parameters, advertisement parameter A and advertisement parameter B.

Boxes 408 represent variations of an advertisement in which all specified advertisement parameters have specific values. Each variation includes a unique set of values for the combination of advertisement parameter values.

Boxes 410 represent predicted performances associated with each of the variations, as determined by the advertisement performance model 400.

In various embodiments, the advertisement performance model 400 may be visible, partly visible to advertisement campaign managers, or information regarding the model 400 may be presented or made available to advertisers. The model feature can be an important marketing tool to encourage and appeal to advertisement campaign managers and increase their participation.

The following is an example of one embodiment of a method implemented by an advertisement performance model. An advertising campaign manager first provides a proposed advertisement, or creative, such as through a user interface.

The advertisement optimization program 114 is then used to run the creative through the advertisement performance model to predict its performance. Specifically, a neighborhood search is carried out. Running the original proposed creative through the model yields a specific node path from the root node to a leaf node. A search is then conducted to find paths through the tree that lead to better performance, while changing a maximum of one advertisement parameter value. If this search is not successful, such as by not producing a satisfactory number or degree of better-performing paths, then another search is carried out including changing at most two advertisement parameter values. The method continues in this way, gradually increasing the number of varied parameters, until the search is successful. When a successful search is completed, the associated variations of the advertisement creative are presented to the advertisement campaign manager. In some embodiments, the variations may be presented along with their predicted performance.

In other embodiments, the advertisement campaign manager is provided with a tool to have an advertisement created for him or her, based on some supplied parameters, such that the created advertisement is predicted to have good or optimal performance. Advertiser time and effort are minimized, yet advertiser preferences and information are utilized and a high-performing advertisement is generated.

Automatic advertisement generation can, for example, help or allow search-based advertisers easily transition to non-search based advertising, improving their overall campaign and ROI. Furthermore, automatic advertisement generation can lower the barrier of entry and cost to engage in graphical display advertisement, allowing participation of small advertisers who might not otherwise be able to do so.

Furthermore, automatic advertisement generation can provide appropriate advertisements where none, or only poorly performing advertisements, may have been available before, thus providing optimization in monetization and preventing wasted advertising opportunities, wasted publisher inventory, etc.

In some embodiments, for example, the advertisement optimization program 114 obtains some basic information from an advertisement campaign manager, such as, for example, a logo, creative text, a landing page, a desired placement or property, demographics, and possibly also keywords or keyword terms. The advertisement performance model is then used to determine one or more better-performing or optimal advertisement variations in accordance with the supplied criteria and information, by testing a number of variations with different advertisement parameter values. The advertisement optimization program 114 includes a template-based creative generator that obtains optimal advertisement parameter values and generates a corresponding one or more advertisements or creatives. The advertisements or creatives may then be recommended to the advertisement campaign manager.

In some embodiments, a model such as described herein can be used differently or for purposes other than or in addition to advertisement optimization. For example, learned models as described herein effectively provide summaries of marketplace knowledge, which can be used, for example, by a company's internal sales force, etc.

In various embodiments, the invention can be used in providing or suggesting modifications to advertisements, or in actually generating advertisements. The invention contemplates any type of advertisement, including, without limitation, content, text, graphics, three-dimensional graphics, animation, video, streaming content, audio or musical content, other ways and manners of conveying information or messages to attempt to influence behavior, etc.

In some embodiments, the invention provides a model that can be used in optimizing or generating optimal advertisements. The model may leverage a large database of historical advertisement or advertisement campaign performance information.

In some embodiments, advertising campaign managers may be provided with generated or new advertisements. In other embodiments, they may be provided with recommendations or suggestions regarding improvements or alterations to advertisements.

Various embodiments of the invention contemplate various degrees of advertiser interactivity and input, or various degrees of automatization. This can include model parameters, which may supplied by the advertiser or obtained or learned by the model, or a combination of both. It may further include advertising parameters, which may also be learned by the model, supplied by the advertiser, or both. It can further include values for advertising parameters, or ranges or a limited selection of values, (where a “value” can broadly include any content or information specifying, satisfying, or fulfilling a parameter, such as in a particular advertisement). Values for parameters, as well, may be learned or automatically obtained, supplied by the advertiser or another party, or a combination of both.

Still further, in various embodiments, the advertiser may or may not supply an advertisement to be modeled or optimized. Furthermore, in various embodiments, an advertiser may or may not identify particular advertisement parameters that are subject to optimization or variation, or a particular number or maximum number of such parameters. In other embodiments, the parameters may be in whole or in part automatically, or without input from the advertiser, obtained, learned, determined, or extracted.

Additionally, in various embodiments, suggestions or recommendations relating to an advertisement or variation of an advertisement may be presented to an advertiser, presented for acceptance, decline, or alteration to an advertiser, or automatically implanted and perhaps presented to or reported to the advertiser whether before or after implementation, or more complex interaction may be enabled.

In some embodiments, the model may be used differently than, separately from, or in conjunction with advertisement recommendation, such as, for instance, in advertisement testing or performance simulation, market, advertisement, or campaign analysis, or for other purposes.

In some embodiments, advertiser-supplied parameters relating to the advertisement performance model can include providing information pertaining to the relevant property, market, demographic or targeting information or groups, size or other parameters or restrictions relating to advertisements, advertiser category, etc.

In some embodiments, advertisers may supply parameters relating to an advertisement that should be taken into account and used in providing and testing variations of the advertisement. Such parameters may include a wide variety of characteristics or information, and may be binary or have multiple possibilities. For example, among other things, such advertising parameters can include type of graphics format, position on a site or Web page, degree of flashiness, whether the ad contain reference to a celebrity, whether the ad contains sophisticated graphics, video or rich media or the degree to which it includes such, specific formatting characteristics, presence, absence or degree of inclusion of particular information or topics, degree of specificity, etc.

In some embodiments, the invention includes interfaces, such as user-interactive graphical user interfaces, that allow the advertiser (or another party) to interact with and provide information that may be used in methods according to the invention, such as by being taken into account in generation or usage of the advertisement performance model. Interfaces may also be used to allow the advertiser or another party to supply or interactively supply or help supply, in whole or in part, advertisement parameters, advertisement parameter values, model parameters, advertisements themselves or aspects or portions of advertisements that should be included, or other information.

Furthermore, in some embodiments, various degrees of interactivity and user-supplied information, relative to automatically obtained or determined information, can be selected by the advertiser to suit the advertiser's needs, time, interest and informational resources, etc.

Still further, in some embodiments, an advertiser or other user can use the model to change or tweak an advertisement or a parameter value of an advertisement, and then obtain or view its performance relative to a previous or different variation.

What is claimed is:

1. A method comprising:
using one or more computers, obtaining a set of values for each of a set of model parameters associated with an advertisement performance model;
using one or more computers, obtaining a set of advertisement parameters associated with variations of an advertisement;
using one or more computers, obtaining, from one or more databases, a set of historical advertisement performance information;
using one or more computers, constructing and storing the advertisement performance model for use in predicting performances of variations of an advertisement;
wherein the advertisement performance model is constructed based at least in part on the set of values for each of the set of model parameters, the set of advertisement parameters, and the set of historical advertisement performance information;
and wherein the advertisement performance model is used to predict performances of each of a set of variations of the advertisement, each of the set of variations of the advertisement comprising a unique set of values for the set of advertisement parameters;
using one or more computers, using the advertisement performance model to determine predicted performances of each of the set of variations of the advertisement; and
using one or more computers, providing and storing a recommendation relating to the advertisement;
wherein the recommendation is based at least in part on the predicted performances;
wherein the recommendation implicitly or explicitly specifies values for each of the set of advertisement parameters;
and wherein the recommendation specifies a variation, of the set of variations of the advertisement, that is determined to have a predicted performance that is better than a determined predicted performance or performances of one or more other variations of the set of variations of the advertisement.

2. The method of claim 1, comprising implementing the recommended variation of the advertisement in an advertisement campaign.

3. The method of claim 1, comprising obtaining an initial advertisement at least in part from an advertiser or advertising campaign manager, and comprising using the advertisement performance model to test variations of the initial advertisement.

4. The method of claim 1, comprising generating an advertisement and recommending the generated advertisement through a graphical user interface.

5. The method of claim 1, comprising recommending a variation with a maximum number of advertisement parameter value changes specified by an advertiser or advertisement campaign manager through a graphical user interface.

6. The method of claim 1, comprising providing predicted performance information along with the recommendation.

7. The method of claim 1, comprising obtaining the set of values for the set of model parameters at least in part from an advertiser or advertisement campaign manager.

8. The method of claim 1, comprising obtaining the set of advertisement parameters at least in part from an advertiser or advertisement campaign manager.

9. The method of claim 1, comprising constructing the model at least in part using a machine learning method.

10. A system comprising:
one or more server computers connected to the Internet; and
one or more databases connected to the one or more servers;
wherein the one or more databases are for storing historical advertisement performance information;
and wherein the one or more server computers are for:
obtaining a set of values for each of a set of model parameters associated with an advertisement performance model;
obtaining a set of advertisement parameters associated with variations of an advertisement;
obtaining, from at least one of the one or more databases, a set of historical advertisement performance information;
constructing and storing the advertisement performance model for use in predicting performances of variations of an advertisement;
wherein the advertisement performance model is constructed based at least in part on the set of values for each of the set of model parameters, the set of advertisement parameters, and the set of historical advertisement performance information;
and wherein the advertisement performance model is used to predict performances of each of a set of variations of the advertisement, each of the set of variations of the advertisement comprising a unique set of values for the set of advertisement parameters;
using the advertisement performance model to determine predicted performances of each of the set of variations of the advertisement; and
providing and storing a recommendation relating to the advertisement;
wherein the recommendation is based at least in part on the predicted performances;
wherein the recommendation implicitly or explicitly specifies values for each of the set of advertisement parameters;
and wherein the recommendation specifies a variation, of the set of variations of the advertisement, that is determined to have a predicted performance that is better than a determined predicted performance or performances of one or more other variations of the set of variations of the advertisement.

11. The system of claim 10, wherein the one or more server computers are further for storing the advertisement performance model in a database.

12. The system of claim 10, wherein the one or more server computers are further for implementing the recommended variation of the advertisement in an advertisement campaign.

13. The system of claim 10, wherein the one or more server computers are further for obtaining an initial advertisement at least in part from an advertiser or advertising campaign manager, and comprising using the advertisement performance model to test variations of the initial advertisement.

14. The system of claim 10, wherein the one or more server computers are further for generating an advertisement and recommending the generated advertisement through a graphical user interface.

15. The system of claim 10, wherein the one or more server computers are further for recommending a variation with a maximum number of advertisement parameter value changes specified by an advertiser or advertisement campaign manager through a graphical user interface.

16. The system of claim 10, wherein the one or more server computers arc further for providing predicted performance information along with the recommendation.

17. The system of claim 10, wherein the one or more server computers are further for obtaining the set of values for the set of model parameters at least in part from an advertiser or advertisement campaign manager.

18. The system of claim 10, wherein the one or more server computers are further for obtaining the set of advertisement parameters at least in part from an advertiser or advertisement campaign manager.

19. The system of claim 10, wherein the one or more server computers are further for constructing the model at least in part using a machine learning method.

20. A computer readable medium or media containing instructions for executing a method, the method comprising:
using one or more computers, obtaining a set of values for each of a set of model parameters associated with an advertisement performance model;
using one or more computers, obtaining a set of advertisement parameters associated with variations of an advertisement;
using one or more computers, obtaining, from one or more databases, a set of historical advertisement performance information;
using one or more computers, constructing and storing the advertisement performance model for use in predicting performance of variations of an advertisement;
wherein the advertisement performance model is constructed based at least in part on the set of values for each of the set of model parameters, the set of advertisement parameters, and the set of historical advertisement performance information;
and wherein the advertisement performance model is used to predict performances of each of a set of variations of the advertisement, each of the set of variations of the advertisement comprising a unique set of values for the set of advertisement parameters;
using one or more computers, using the advertisement performance model to determine predicted performances of each of the set of variations of the advertisement; and
using one or more computers, providing a recommendation relating to the advertisement;
wherein the recommendation is based at least in part on the predicted performances;
wherein the recommendation implicitly or explicitly specifies values for each of the set of advertisement parameters;
and wherein the recommendation specifies a variation, of the set of variations of the advertisement, that is determined to have a predicted performance that is better than a determined predicted performance or performances of one or more other variations of the set of variations of the advertisement.
